(19) United States
(12) Patent Application Publication
(10) Pub. No.: US 2004/0069591 A1
(43) Pub. Date: Apr. 15, 2004

(54) Token dispensing and banknote changing device

(76) Inventor: Yoshitaka Ito, Tokyo (JP)

Correspondence Address: SNELL & WILMER LLP, 1920 MAIN STREET, SUITE 1200, IRVINE, CA, 92614-7230, US

(21) Appl. No.: 10/647,402

(22) Filed: Aug. 25, 2003

(30) Foreign Application Priority Data
Aug. 27, 2002 (JP) 2002-247805

(51) Int. Cl. G07F 7/04

(52) U.S. Cl. 194/206

(57) ABSTRACT

A chassis divided by partitions into compartments arranged in a vertical column and containing a banknote dispensing unit, a banknote receiving unit, a token dispensing unit, and a control unit operatively connected to detect receipt of one or more banknotes, dispense zero or more tokens, and dispense zero or more banknotes. The banknote receiving guide for the banknote receiving unit, the token dispensing guide for the token dispensing unit, and the banknote dispensing guide for the banknote dispensing unit are arranged to be easily accessible to a user seated at a gaming machine adjacent to the token dispenser.

### CROSS-REFERENCE TO RELATED APPLICATION

This application is based on an application number 2002-247805 filed in japan, dated Aug. 27,2002.

### FIELD OF THE INVENTION

The present invention is related to a token dispensing device. More particularly, the present invention is related to a token dispensing and banknote changing device for use in a gaming environment where the inserting of banknotes and taking out tokens and dispensed banknotes is more convenient for the user.

### DESCRIPTION OF RELATED ART

A banknote dispensing device may be included together with a banknote accepting device and a token dispensing device to comprise a token purchasing station for use in a gaming environment. Gaming devices are often of a standard size and it is desirable for a token purchasing station to be of a corresponding size with the gaming devices. Often a token purchasing station will be placed between gaming devices and it is desirable that the token purchasing station should have a similar profile.

It is common that a user of gaming device would be seated on a stool or in a chair directly in front of the gaming device. From this position, it is desirable to reduce the movement of the user in order to continue playing the gaming device. For example, when the user wishes to purchase additional game tokens, it is desirable that the user not be required to stretch too far from their seated position. An example, prior art system is described in the Japanese laid open patent publication 6-190138.

Previously, the dispensing tray of the token dispensing device was located at a position almost level with a seated user's eyes. It is understandable that for some users this position would be too high and require the user to stretch or stand up in order to be certain they had retrieved all of their purchased tokens. Similarly, the banknote receiving position and the banknote dispensing position were located too far apart, requiring a user to scan and reach a farther distance in order to retrieve any dispensed banknotes.

Given these constraints, a compact token dispensing and banknote changing device that is more convenient to use is needed. The compact banknote dispensing device should be narrow in width, while conforming to the depth and height profile of adjacent gaming devices.

Common dimensions for such a desirable compact dispensing device are limited to 810 mm height, 100 mm width, and 240 mm depth. However, the size of the banknote used has an effect on the depth of the token dispensing and banknote changing device. A longer banknote would typically require the depth of the dispensing device to become longer.

In some regions, a larger (longer) banknote is used to convey a larger denomination value. Hence, the size limitations on the banknote automatically limit the denomination value that may be dispensed which would ensure that only lower value denominations are used for the dispensing device.

This lower value denomination may be undesirable because the number of banknotes stored in the dispensing device is limited, and dispensing a higher amount would require the banknote dispensing device to dispense a larger number of banknotes, and thereby deplete the banknote supply more rapidly.

The addition of sensors to determine the validity of the banknotes prior to dispensing also contributed to the increasing size of the dispensing device, requiring a dispensing path of a required length to allow the dispensing device to accurately measure some artifact of the banknote prior to dispensing the banknote, in order to avoid dispensing erroneous banknotes.

Previously, internal to a banknote dispensing unit, when a banknote was discharged or let off from a banknote supply storing section at one speed and then taken up by a transporting unit at a higher speed, the banknote would be damaged due to the difference in speeds. Usually, the damage to the banknote occurs because the drive mechanisms, such as feed rollers, that contact the banknote in both the banknote supply storing section and the banknote transporting unit are simultaneously engaged with the banknote while driving the banknote at different speeds. This difference in speeds may apply a shearing force to the banknote thereby damaging the banknote.

One attempt to address this problem has been to provide a drive mechanism with a projection on the periphery of the drive mechanism. This projection is used to positively engage a banknote and move it in the direction of the transport unit feed rollers. However, the drive mechanism with the projection should not have contact with the banknote at the point the banknote engages with the transport unit feed rollers since the projection could cause damage to the banknote.

Instead, the drive mechanism with the projection only engages the banknote for a portion of the travel, and allows the banknote to continue for a period of time before engaging with the transport unit feed roller. This period of time where the banknote is not positively engaged, with either the drive mechanism with a projection or the feed rollers of the transport unit, allows the banknote to travel freely and may allow the banknote to stall or become misaligned.

In an attempt to reduce the time the banknote is not positively driven, another device including a drive mechanism with a clutch was used. The clutch mechanism determines when the drive mechanism is driving the banknote and can be declutched, or disengaged, from driving prior to the moment the banknote arrives at the transporting feed rollers.

This method requires a very precise control of the declutching so as to avoid any time when the banknote is both driven simultaneously by the drive mechanism of the banknote supply storing section and being pulled by the feed rollers of the banknote transport unit. If the declutching occurs too late, the banknote may be damaged as discussed above. If the declutching occurs too early, the banknote may stall or become misaligned causing jamming or other malfunction.

Finally, a compromise method was used that allows a limited freedom to advance the banknote as it is discharged by a banknote supply storing section and then pulled at a higher speed by a transport unit such as that described in the Japanese laid open patent publication 6-92491. In this case, a drive shaft with a radial projection drives a feed roller in one direction of rotation. The projection is within a cavity region within the feed roller so that the feed roller may be advanced in the direction of rotation a limited amount, causing the projection to loose contact with the driven edge. This allows a limited amount of rotational freedom where the disengagement of the projection with the feed roller allows the banknote to be advanced. This method suffers from the obvious limitation that the feed roller only allows a limited amount of advancement of only ¼ turn in the cited reference.

### SUMMARY OF THE INVENTION

The present invention provides a token dispensing and banknote changing device for use in a gaming environment. Within the token dispensing and banknote changing device is a banknote receiving unit, a banknote dispensing unit, and a token dispensing unit, and a control unit stacked in a vertical column. Typically, a user deposits one or more banknotes into the token dispenser, and the user receives a quantity of tokens, while the difference between the value of the banknotes deposited and the value of the tokens dispensed, if any, is refunded to the user in the form of dispensed banknotes.

The token dispensing and banknote changing components are arranged to make it easy to use, and to minimize movement required by a user while seated at an adjacent gaming machine. In the token dispensing and banknote changing device, the banknote dispensing unit is located above the banknote receiving unit. The banknote dispensing unit has a slot for dispensing banknotes that is located at a lower portion of the dispensing unit while the banknote receiving unit has a slot for receiving banknotes that is located at an upper portion of the receiving unit.

This arrangement provides that the banknote receiving slot and the banknote dispensing slot are located close to each other at a location almost level with the user's eyes to make it easy for the user to see both the dispensing slot and the receiving slot by turning their head to the side. Further, the banknote dispensing slot is located above the banknote receiving slot to make it easy for the user to notice when a banknote has been dispensed, and avoids an accidental loss for the user.

The user will typically insert one or more banknotes into the banknote receiving unit and will receive a quantity of tokens based on the value of the banknotes deposited. The difference between the value of the banknotes deposited and the tokens received will be refunded to the user in the form of banknotes dispensed from the banknote dispensing unit. All of these operations are under the direction of a control unit that receives information signals from and sends command signals to the banknote receiving unit, the token dispensing unit, and the banknote dispensing unit.

The banknote dispensing unit includes a banknote supply storing section for storing banknotes, a banknote discharging unit for discharging the banknotes at a first speed, a banknote transporting unit for transporting the discharged banknote at a second, higher speed, a U-shaped banknote guiding unit, a diverting unit for diverting unacceptable discharged banknotes to a rejected banknote storing section, a package dispensing unit to dispense the acceptable discharged banknotes, and a control unit for receiving signals from and controlling the actions of the dispensing device.

The banknote supply storing section retains the stored banknotes at an angle measured with the horizontal. This allows the banknote storing section have a smaller profile in the depth dimension for the same size banknotes as was previously possible. Correspondingly, the angled storing allows the banknote supply storing section to retain larger denomination (longer) banknotes in the same depth dimension as was previously possible.

The length sensor includes two banknote sensors disposed on a U-shaped transporting path. The U-shape of the transporting path allows the transported banknote to traverse a longer linear distance, while the actual depth required is less due to the folding over of the transporting path into the U-shape. This U-shape transport path and the angled banknote storing section provide the compact size of the dispensing device.

The length sensor outputs signals to a control unit that interprets the signals to determine whether the dispensed banknote is acceptable. An unacceptable banknote is discharged to a rejected banknote storing section, while the acceptable banknotes are discharged to a temporary storing section. Once a predetermined number of banknotes are accumulated in the temporary storing section, they are all dispensed at one time to a dispensing slot from which a user can grasp.

The predetermined number of discharged banknotes may be any permissible number determined by the banknote dispensing control unit 7. For example, the predetermined number of discharged banknotes can be four in order to accommodate change from a five dollar bill, or can be nine in order to accommodate change from a ten dollar bill. The local banknotes used, the parameters of the control unit operation, and the predetermined number of discharged banknotes may vary.

banknote from a banknote supply storage section at one speed to a banknote transporting unit at a second, higher speed while avoiding damage to the banknote due to this difference in speed in the transfer.

The banknotes are discharged from the banknote supply storing section by the banknote discharge unit using a feed roller driven by a one-way clutch at a first predetermined speed. The discharged banknote is received by the banknote transporting device that pulls the discharged banknote at a second predetermined speed which is faster than the first speed. When the banknote is pulled at the second, faster speed, the one-way clutch driving the feed roller in the discharge unit automatically allows the banknote to be continuously pulled at the faster speed without damaging the banknote.

The dispensing device includes five sensors, three motors, and a solenoid (magnetically actuated) device. The first sensor detects the banknote as it is received by the transporting device. The second sensor detects the presence of the discharged banknote in as it travels past the U-shaped guiding unit. The third sensor detects the presence of the banknote at the rejected banknote discharge point from the dispensing device. The fourth sensor detects the presence of the banknote at the normal banknote discharge point. The fifth sensor detects the accumulated banknotes as they are dispensed from the dispensing device. The first motor drives the discharging unit while the second motor drives the transporting unit. The solenoid actuates a diverting board for selectively diverting rejected banknotes into a rejected banknote storing section. The third motor drives the dispensing unit.

The dispensing device includes a control unit that interprets the signals from the sensors to determine whether the banknote has been discharged and transported properly. The control unit outputs signals to activate the motors and the solenoid. When an error condition is detected, the motors are stopped and an audible alarm is sounded.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings.

FIG. 1 shows an embodiment of the present invention.

FIG. 2 shows a front view of the token dispensing and banknote changing device located between gaming machines.

FIG. 3 shows an outline view of the banknote dispensing unit.

FIG. 4 shows a prior art token dispensing and banknote changing device adjacent to a gaming machine.

FIG. 5 shows the removable safe unit from the banknote dispensing unit.

FIG. 6 shows the interposed radial extensions of the first roller and the first pressing roller showing how the radial extensions alternate in a direction along the axis of rotation.

FIG. 7 shows an embodiment of the one-way clutch where the driving shaft is driving the peripheral edge of the feed roller.

FIG. 8 shows an embodiment of the one-way clutch where the peripheral edge of the feed roller is allowed to advance faster than the rotation speed of the driving shaft.

FIG. 9 shows the normal transfer of a banknote from the banknote supply storing device through the banknote transport device to the temporary banknote storing section and then the dispensed banknotes being taken by a user.

FIG. 10 shows the rejected transfer of a banknote from the banknote supply storing device through the banknote transport device to the rejected banknote storing section.

FIG. 11 shows a jamming transfer of a banknote from the banknote supply storing device through the transport device where the discharged banknote becomes jammed prior to the second transporting unit and does not successfully pass through the banknote transport unit. Banknote transfer jamming may occur at other locations within the dispensing device.

FIG. 12 shows a side view of the first door where the first door may pivot around a pin and the first door is removable.

### DETAILED DESCRIPTION OF THE PREFERRED EMBODIMENTS

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the intention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

In this specification, a banknote may be paper currency, a certificate, a bill, a note, or any similar thin, flexible article of a substantially rectangular shape that may be stored, manipulated, and dispensed as herein described. A token may be a coin, a medallion, a pachinko ball, or other similar article that may be used in a gaming machine.

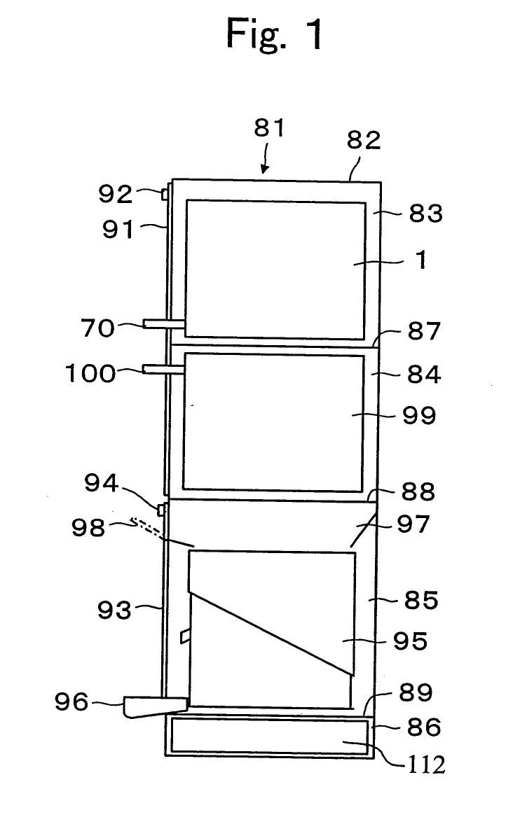

In reference to FIG. 1, the token dispensing and banknote changing device 81 includes a box-like chassis 82 that is divided into compartments or sections by partitions (87, 88, 89). The compartments are arranged in a vertical column with the banknote dispensing compartment 83 containing a banknote dispensing unit 1 located in the top columnar position, a banknote receiving compartment 84 containing a banknote receiving unit 99 in the middle columnar position, and a token dispensing compartment 85 containing a token dispensing unit 95 located at the bottom columnar position.

The vertical chassis has a rear face, two side faces, a top face, and a bottom face that are typically closed. The vertical chassis front face is typically covered by doors that may be opened. The rear face of the third compartment 85 has an opening to permit resupply of tokens to the token dispensing unit.

The banknote dispensing unit 1 dispenses one or more banknotes through a banknote dispensing guide 70 under the direction of the control unit 112. The banknote dispensing guide 70 is located at approximately the lower portion, or lower side, of the banknote dispensing unit 1. The banknote dispensing guide 70 is oriented to protrude out of the front face of the chassis 82.

The banknote receiving unit 99 receives one or more banknotes and communicates with the control unit 112 to indicate the banknotes received. The banknote receiving guide 100 for receiving deposited banknotes from the user is located at approximately the upper portion, or upper side, of the banknote dispensing unit 1. The banknote receiving guide 100 is oriented to protrude out of the front face of the chassis 82.

The token dispensing unit 95 dispenses tokens under the direction of the control unit 112. The token dispensing unit 95 dispenses tokens into a token dispensing tray 96 which is located at approximately the lower portion, or lower side, of the token dispensing unit 95. The token dispensing tray 96 is oriented to protrude out of the front face of the chassis 82.

The banknote dispensing compartment 83 and the banknote receiving compartment 84 are enclosed by a first door 91. The first door 91 has a first locking mechanism 92 to securely enclose the compartments against unauthorized tampering. The first door 91 preferably has a hinge on the lower (third) edge of the door, to pivotably connect with the chassis 82. Alternatively, the hinge for the second door may be located on either (second, fourth) side of the second door 91. The banknote dispensing guide 70 and the banknote receiving guide 100 protrude through the first door 91.

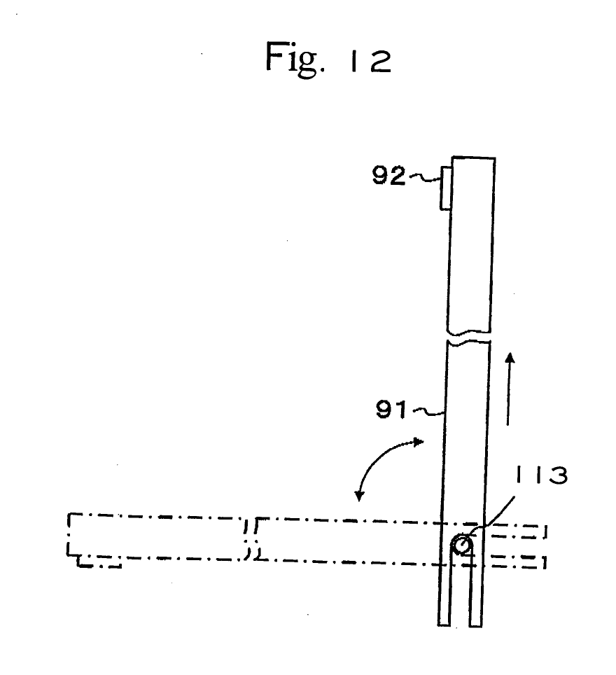

According to FIG. 12, the hinge for the first door 91 can be a first pivot pin 113 or rod traversing the width of the first door frame within a lower portion of the second compartment of the chassis 82. The third edge (bottom portion) of the first door 91 has an open slot region traversing an interior portion so that it can removably attach to the chassis 82. To attach the first door 91 to the chassis 82, the first door 91 is held in a horizontal manner and the third edge is moved towards the first pivot pin 113. The first door 91 begins to engage the first pivot pin 113 and becomes fully engaged when a suitably curved portion of the open slot region rests against the first pivot pin 113. After the first door 91 is fully engaged with the first pivot pin 113, the first door may be rotated about the first pivot pin 113 to a vertical position in order to fully enclose the first compartment and so that the first locking mechanism 92 can engage the chassis 82.

The hinge and the locking mechanism may be located oppositely on either the first and the third edges or the second and fourth edges of the first door 91. Alternatively, the banknote dispensing guide 70 and the banknote receiving guide 100 may be incorporated into the first door 91, so that the banknote dispensing guide 70 and the banknote receiving guide 100 move with the first door 91 when the first door 91 is opened or removed.

The token dispensing compartment 85 containing the token dispensing unit 95 is closed by a second door 93. The second door has a locking mechanism 94 to securely enclose the compartments against unauthorized tampering. The second door 93 preferably has a second hinge on the lower (third) edge of the door, to pivotably connect with the chassis 82. Alternatively, the second hinge for the second door may be located opposite the second locking mechanism on either (second, fourth) side of the second door 93.

Similar to the first door 91 shown in FIG. 12, the hinge for the second door 93 can be a second pivot pin or rod traversing the width of the first door frame within a lower portion of the third compartment of the chassis 82. The third edge (bottom portion) of the second door 93 has an open slot region traversing an interior portion so that it can removably attach to the chassis 82. To attach the second door 93 to the chassis 82, the second door 93 is held in a horizontal manner and the third edge is moved towards the second pivot pin. The second door 93 begins to engage the second pivot pin and becomes fully engaged when a suitably curved portion of the open slot region rests against the pivot pin. After the second door 93 is fully engaged, the second door 93 may be rotated to a vertical position to fully enclose the first compartment such that the first locking mechanism 94 can engage the chassis 82.

The second hinge is on the opposite edge of the second door 93 from the second locking mechanism 94. The second hinge and the second locking mechanism 94 may be on either the first and the third edges or the second and fourth edges of the second door 93. The token dispensing unit dispenses tokens into the token dispensing guide 96 that protrudes through the second door 93. Alternatively, the token dispensing guide 96 may be incorporated into the second door 93, so that the token dispensing guide 96 moves with the second door 93 when the second door 93 is opened or removed.

The banknote receiving unit 99 receives one or more banknotes deposited by a user to purchases game tokens for use in a gaming machine or other similar environment. The banknote receiving unit 99 receives one or more banknotes or other similar article from the user through the banknote receiving guide 1 00 and communicates to the control unit 112 the amount or value of the banknote inserted into the banknote receiving unit 99.

The token dispensing unit 95 dispenses tokens into a token dispensing tray in response to the command of the control unit 112 based on the value of the banknote deposited by the user into the banknote receiving unit 99. The controller will cause the token dispensing unit 95 to dispense a number of tokens less than or equal in value to the banknote deposited by the user. The difference will usually be less than the value of a single token, and will be refunded to the user.

The token dispensing unit 95 has a token supply hopper for holding tokens that may be periodically refilled as the supply becomes low. The token dispensing unit hopper may be refilled automatically by an automatic token resupply device that has a chute or conduit for refilling the token dispensing hopper through the rear of the chassis 82. The token dispensing unit hopper may also be refilled manually by opening a token resupply door 98 which is incorporated into the second door 93. This token resupply door 98 allows easy access to resupply the tokens in the token dispensing unit hopper from the front of the chassis 82. The token resupply section 97 is located above the token dispensing unit hopper.

The banknote dispensing unit 1 dispenses one or more banknotes through the banknote dispensing guide 70 under the direction of the banknote dispensing control unit 7 in order to refund to the user the difference between the value of the banknotes deposited by the user and the value of the tokens dispensed to the user. If the value of the tokens dispensed by the token dispensing unit 95 is equal to the value of the banknotes deposited by the user in the banknote receiving unit 99, then the banknote dispensing unit will not dispense any banknotes.

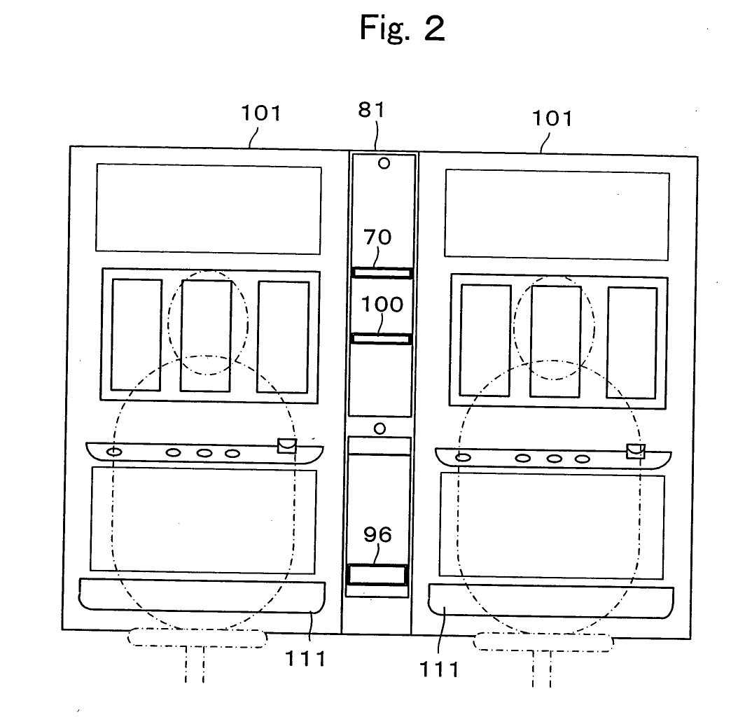

As shown in FIG. 2, the token dispensing and banknote changing device 81 may be disposed adjacent to a gaming machine 101, or is disposed between two gaming machines. The banknote dispensing guide 70 is located at about eye-level for a user seated at a gaming machine 101. The banknote receiving guide 100 is arranged just below the banknote dispensing guide 70, and is within easy reach of a user seated at an adjacent gaming machine. The token dispensing tray is located near the bottom of the token dispensing and banknote changing device so that the token tray 96 is near the bottom portion of a gaming machine 101, and is easy to reach.

Further, many gaming machines dispense winning tokens near the bottom portion of the particular game machine. Hence, it is natural for a user to expect to pick up tokens from the bottom portion of a device arranged adjacent to a gaming machine, especially a gaming machine that dispenses winning tokens from the bottom portion of the gaming device.

The particular arrangement is desirable because the user can easily see when any banknotes are dispensed by simply turning their face to the side towards the token dispensing and banknote changing device. The banknote receiving guide 100 is located near the middle of the token dispensing and banknote changing device 1, and is within easy reach of a user seated at an adjacent gaming machine.

Finally, the token dispensing tray 96 is easy to reach for a user seated at a gaming machine, without requiring the user to get up from their seat or stretch very far to reach the dispensed tokens. This minimizes the movements of the user, and provides a more comfortable gaming environment. The profile, or outside dimensions of the token dispensing and banknote changing device are matched with the standard dimensions of the gaming machines where the token dispensing and banknote changing device is installed.

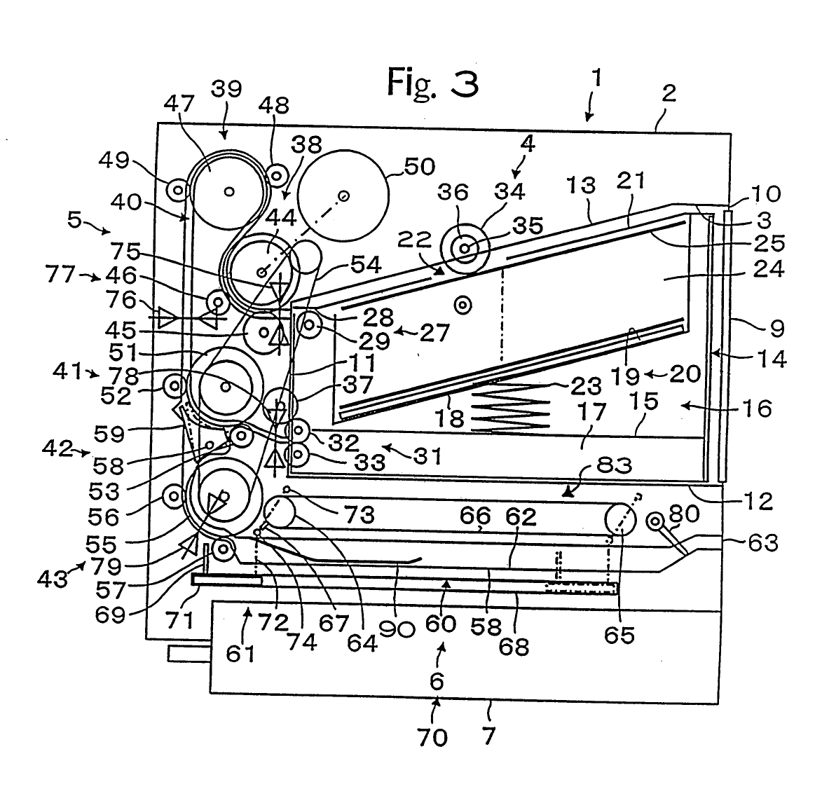

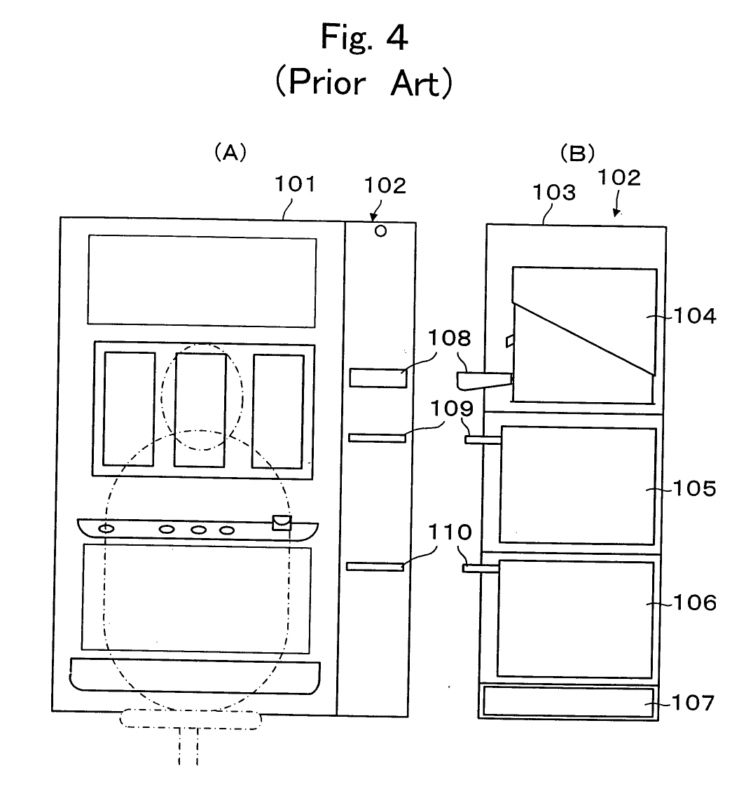

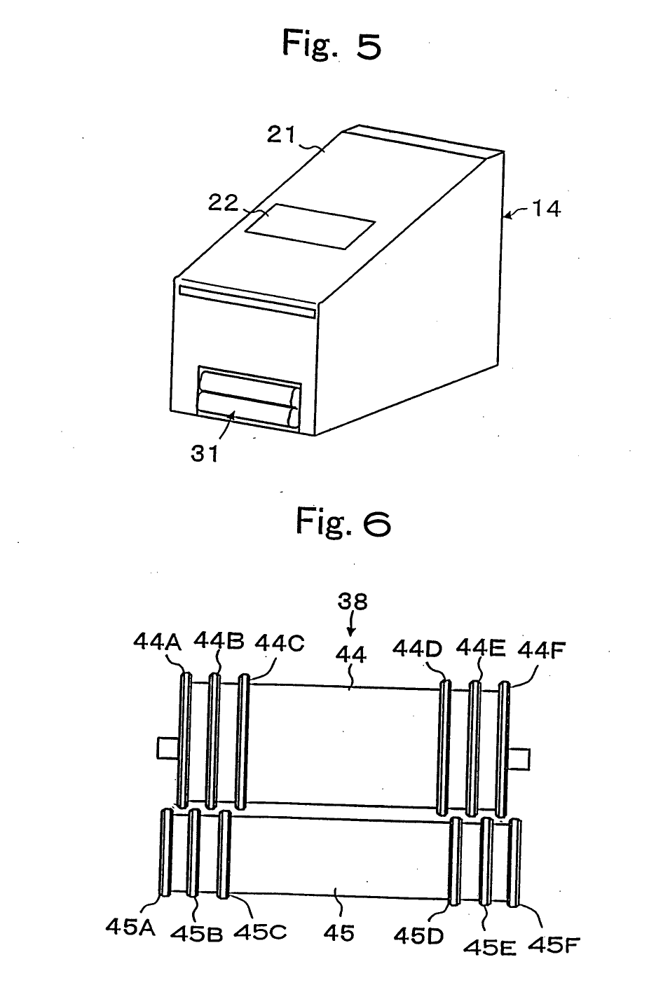

In reference to FIG. 3, the banknote dispensing unit 1 utilizes a one-way clutch 36 for transferring a banknote from a banknote supply storing section 24 at one speed to a banknote transporting unit 5 at a second, higher speed while avoiding damage to the banknote due to the difference in speed in the transfer.

The banknote dispensing unit 1 includes a banknote supply storing section 24 for storing banknotes, a banknote discharging unit 4 for discharging the banknotes at a first speed, a banknote transporting unit 5 for transporting the discharged banknote at a second, higher speed, a package dispensing unit 6 to outputting the discharged banknotes, and a banknote dispensing control unit 7 for receiving signals from and controlling the actions of the banknote dispensing unit 1.

The banknote discharge unit 4 includes a first motor 81 (not shown) driving a driving shaft 35. The driving shaft in turn drives a one-way clutch 36 that drives a feed roller 34. The banknote dispensing control unit 7 enables the first motor 81 to drive the feed roller 34 in order to discharge banknotes from the banknote supply storing section 24.

The feed roller 34 has a peripheral edge adjacent to the banknote supply storing section 24 that contacts one of the stored banknotes 25 in the banknote supply storing section. The feed roller 34 discharges a stored banknote 25 to the banknote transporting unit 5 at a first predetermined speed that depends on the rotation speed of the feed roller 34 driven by the one-way clutch 36 which is driven by a driving shaft 35.

The discharged banknote is pulled into the transporting unit 5 at a second speed, which is faster than the first speed. When the banknote is pulled at the second, faster speed, feed roller 34 is still in contact with the banknote and the one-way clutch 36 driving the feed roller 34 automatically allows the banknote to be continuously pulled at the faster speed while avoiding excessive strain on the banknote at this transition.

The transporting unit 5 includes a first transporting unit 38 for receiving the discharged banknote and moving the banknote through an initial portion of the transporting unit 5, a second transporting unit 41 for receiving the discharged banknote from the first transporting unit 38 and moving the banknote through an intermediate portion of the transporting unit, a diverting unit 42 for diverting a defective banknote to a rejected banknote storing section 17, a third transporting unit 43 for receiving the discharged banknote from the second transporting unit 41 and moving the banknote through a final portion of the transporting unit, and four sensors (75, 76, 78, 79) that are used to determine if the banknote has been transported successfully through the transporting unit 5. A fifth sensor 80 is used to determine when banknotes have been dispensed and subsequently removed by a user.

The path from the first transporting unit 38 through the second transporting unit 41 to the third transporting unit 43 is considered a first path, and is the normal path a discharged banknote will take if the banknote is not defective and the banknote transporting unit 5 does not jam or otherwise fail to properly transport the discharged banknote. This first path may also be called the normal banknote discharge path since the banknote will be normally be discharged to the temporary discharge section 60.

The path from the first transporting unit 38 through the second transporting unit 41 and to the diverting unit 42 and the rejected banknote storing section is considered a second path, and is the path a discharged banknote will take if the banknote is determined to be unacceptable for dispensing. This second path may also be called the rejected banknote storing path since the rejected banknote will be stored in the rejected banknote storing section 17.

The five sensors (75, 76, 78, 79, 80) may be of various designs such as a transmitting photoelectric sensor, a reflecting photoelectric sensor, or mechanical sensor to detect the presence of a banknote between the emitter/receiver pair in order to determine the presence and length of the banknote given the known transport speeds of the moving elements.

More sophisticated sensors may be employed to detect properties other than the length of the banknote. These properties may be the particular denomination, composition of the banknote, or some other distinguishing feature that the banknote dispensing control unit 7 may use in order to determine whether the banknote is acceptable for dispensing.

The five sensors (75, 76, 78, 79, 80) each output a signal. The term signal may reflect either a particular electrical property such as a voltage or impedance level, or it may reflect a time-sequence of a particular electrical property such as a voltage or impedance waveform.

The first sensor 75 detects a banknote as it is received by the first transporting unit 38 of the banknote transporting unit 5. The second sensor 76 detects a discharged banknote in the U-shaped transport passageway 40. The third sensor 78 detects a diverted banknote as it is entering the rejected banknote storing section 17. The fourth sensor 79 detects the presence of the banknote as it is emitted from the transporting unit 5 at the normal discharge point into the temporary storing section 60.

The fifth sensor detects the accumulated banknotes as they are protruding out of the dispensing slot 63. The banknote dispensing control unit 7 receives signals from the sensors and compares the received signals to determine whether the banknote was discharged, transported, and dispensed properly.

The diverting unit 42 is used to route a selected banknote to a rejected banknote storing section 17 by interposing a deflecting element called a diverting board 59 into the path of the banknote after it is received by the banknote transporting unit 5. The deflecting element is normally interposed to deflect a transported banknote and is moved to a non-interposing position if the transported banknote is determined to be acceptable for dispensing. A banknote may be rejected if it is detected to be defective or inappropriate by the banknote dispensing control unit 7 after interpreting the signals from the length sensor 77.

The length sensor 77 is composed of the first sensor 75 and the second sensor 76 which are used together to determine the length of the transported banknote. In many applications, banknotes of different sizes indicate different denominations. A larger denomination is commonly a physically larger banknote both in length and width. Hence, by precisely detecting the actual length and comparing to an expected length, the denomination may be accurately determined.

Most commonly, a banknote would be found to be unacceptable if the signals from the length sensor 77 indicate the banknote is the wrong size, either too long or too short. Such a banknote would not be dispensed, and would instead be stored in the rejected banknote storing section 17. A damaged or torn banknote may also be detected in this manner.

Once the predetermined number of banknotes are accumulated in the temporary storing section 60, the dispensing pusher unit 61 is used to dispense the accumulated discharged banknotes to the user. The package dispensing unit 6 is activated by the banknote dispensing control unit 7.

The package dispensing unit 6 receives a predetermined number of discharged banknotes from the third transporting unit 43 prior to dispensing the assembled banknotes to a user. The package dispensing unit 6 includes the temporary storing section 60 and the dispensing pusher unit 61. The temporary storing section includes tray 58 and the banknote retainer 90. Tray 58 is located adjacent the eighth pressing roller 57 and the tray bottom 62 is slightly longer than the largest acceptable stored note 25. Banknote retainer 90 can be a blade spring fixed at a short distance to fourth roller 55 and the other end is located near to and parallel with the tray bottom 62. Banknote 25 is fed to tray 58 by the third transporting unit 43 and is held by the banknote retainer 90.

The dispensing pusher unit 61 includes slider unit 71, guiding rail 68, and belt transporting unit 83. Slider unit 71 includes pushing block 69 and driven plate 72. Pushing block 69 and driven plate 72 extend in a perpendicular manner from slider 71. Driven plate 72 has two segments, the first segment being perpendicular to the slider unit 71, the second segment being connected to the first segment, but extending at an angle inclined in the direction of the dispensing slot 63. At the end of the driven plate 72, at a point farthest from the slider unit 71, is the first driven pin 73. At the junction of the two segments of the driven plate 72 is the second driven pin 74.

The belt transporting unit 83 includes timing belt 66, first timing pulley 64, second timing pulley 65, a projection 67 that is perpendicular to the exterior surface of the timing belt 66, and a third motor 82 (not shown). In reference to FIG. 3, with the slider unit 71 in a first position on the far left side of the guiding rail 68, the third motor 82 starts and drives the timing belt 66 to rotate in a counter clock-wise fashion. As the timing belt 66 rotates, the projection 67 makes contact with the second driven pin 74 to push the slider unit 71 along the guiding rail 68 in a direction from left to right as shown in FIG. 3.

The slider unit 71 moves from left to right along guiding rail 68 to cause the pushing block 69 to contact the accumulated banknotes in the temporary storing tray 58 and push the accumulated banknotes to the right, past banknote sensor 80 in order that a portion of the assembled banknote package will protrude from the dispensing slot 63 in order to be grasped by the hand of a user.

After the slider unit 71 reaches the second position, at the far right side of the guiding rail 68, the timing belt 66 continues to move in a counter clock-wise fashion. The projection 67 breaks contact with the second driven pin 74 and follows the curvature of the second timing pulley 65 until the projection 67 makes contact with the first driven pin 73 on the driven plate 72.

As the timing belt continues to move in a counter clock-wise fashion, the projection 67 pushes the first driven pin 73 and the driven plate 72 back to the left, breaking contact with the recently pushed banknotes, and returning the slider unit 71 to a position in preparation to push subsequent accumulated banknotes to the dispensing slot. Once the slider unit 71 reaches the terminal point at the left side of the guiding rail 68, the projection 67 breaks contact with the first driven pin 73 and follows the curvature of the first timing pulley 64. The third motor 82 then stops.

The dispensing slot 63 is aligned with the banknote dispensing guide 70 as shown in FIGS. 1-2. While the accumulated banknotes are dispensed and waiting for a user to take them, the sensor 80 will indicate their position as dispensed and waiting. Once the accumulated banknotes are taken by a user, the sensor 80 will indicate the banknotes are no longer protruding from the dispensing device 1. If the dispensed banknotes are not picked up by the user in a predetermined amount of time, the controller will cause an audible alarm to sound indicating this condition.

In reference to FIG. 3, the banknote dispensing unit 1 includes a box-like chassis 2. The box-like chassis 2 has a cavity that is adapted to receive a banknote safe 14 into a banknote safe attaching section 3. Opening 10 of the safe attaching section 3 can be a closed lid 9 which can pivot at chassis 2. Safe attaching section 3 includes a long edge which extends up and down at opening 10, a short edge 11 which faces the long edge 10 is parallel, lower edge 12 which is located between the long edge and the short edge is horizontal and slanting edge 13 which faces the lower edge 12.

The banknote safe attaching section 3 has a substantially trapezoidal shape to accommodate the banknote safe 14 which includes the banknote supply storing section 24 for retaining stored banknotes 25 at an angle inclined to horizontal. The banknote safe 14 comprises a removable storage unit that is ruggedly constructed for increased durability and to resist tampering.

The stored banknotes 25 are held at an inclined angle in the banknote supply storing section 24 to accommodate larger banknotes in a shorter longitudinal length of the banknote dispensing device 1, and to facilitate the discharge of banknotes by the assistance of gravity as the banknotes are discharged in a slightly downward direction. The shorter longitudinal length allows the dispensing device 1 to occupy a more compact space while dispensing larger banknotes.

Inside of banknote safe 8 is a banknote supply storing section 24 for retaining stored banknotes 25 prior to dispensing and a rejected banknote storing section 17 for retaining banknotes that have been rejected during dispensing. The banknote supply storing section 24 is separated from the rejected banknote storing section 17 by the separating plate 15.

Pushing plate 19 is arranged underneath the stored banknotes 25 and is biased by a spring 23 to apply pressure to the stored banknotes 25 in order to maintain the stored banknotes 25 in a position against the feed roller 34 which extends through the opening 22. When a stored banknote 25 is discharged from the banknote supply storing section 24 by the feed roller 34, the discharged banknote slides in a slightly downward direction and through an exit point 84 (not shown) where the separating unit 27 ensures discharged banknotes are separated one-by-one to prevent the discharge of more than one banknote at a time.

Separating unit 27 includes fixed wall 28 which is straight and connects slanting wall 21 and moving roller 29 which is a rotatable cylinder and can be away from the fixed wall 28 a predetermined distance. Banknotes are discharged from the banknote supply storing section 24 at a first speed determined by the rotation speed of the feed roller 34. Once the discharged banknote passes separating unit 27, the discharged banknote passes the first sensor 75 and is received by first transporting unit 38 in the banknote transporting unit 5.

The first sensor 75 outputs a first signal to the banknote dispensing control unit 7 indicating the beginning, end, and duration of time the banknote is detected by the first sensor 75 based on the transport speed of the banknote in the first transporting unit 38. The beginning, end, and duration describe a time-based waveform having a rising edge, a falling edge, and a detected value.

After the discharged banknote passes through the U-shaped banknote passageway 40, the discharged banknote passes the second sensor 76. The second sensor outputs a second signal to the banknote dispensing control unit 7 indicating the beginning, end, and duration of time the banknote is detected by the second sensor 76 based on the transport speed of the banknote in the first transporting unit 38. The first sensor 75 and the second sensor 76 together comprise the length sensor 77.

The length sensor 77 is used to determine the length of a discharged banknote in order to determine if the banknote is acceptable for dispensing. If the discharged banknote is acceptable for dispensing, the diverting unit 42 is activated by the banknote dispensing control unit 7 by energizing the diverting solenoid 85 (not shown). In reference to FIG. 3, the diverting solenoid 85 rotates the fixed shaft 58 to rotate the diverting board 59 in a clockwise fashion in order to bring the diverting board 59 to a position to allow the discharged banknote to pass from the second transporting unit 41 to the third transporting unit 43.

Conversely, if the banknote is not acceptable for dispensing, the banknote dispensing control unit 7 will not energize the diverting solenoid 85, and the discharged banknote will be diverted by the diverting board 59 to a second path leading to the rejected banknote storing section 17.

Given the known parameters of the transport speed of the discharge unit 4, the discharge speed of the first transporting unit 38, and the expected length of the banknote, the banknote dispensing control unit 7 can determine if the banknote is defective and should be retained in the rejected banknote storing section 17 rather than dispensed from the banknote dispensing unit 1.

The first transporting unit 38 includes a second motor 50 for driving a first roller 44 and a guiding unit 39 for driving a discharged banknote through the initial portion of the banknote transporting unit 5. The first roller 44 has a companion first pressing roller 45 arranged adjacent to the first roller to form a passage for the discharged banknote between the adjacent rollers.

In reference to FIG. 3, the first roller 44 and the first pressing roller 45 having two or more rotating projections (44A-44F and 45A-45F) radially protruding from the surface of the first roller 44 and the first pressing roller 45. The rotating projections are arranged in an staggered, alternating, or offset manner to allow the first roller and the first pressing roller to grasp a discharged banknote in a wave-like manner. The description wave-like refers to the alternating up and down deflections perpendicular to the direction of travel between the opposing first roller 44 and first pressing roller 45.

In reference to FIG. 1, the first roller 44 has a companion second pressing roller 46 arranged adjacent to the first roller to form a passage for the discharged banknote between the adjacent rollers after the discharged banknote has passed through the passage created by the first roller 44 and the first pressing roller 46.

The guiding unit 39 is arranged adjacent to the second motor 50 and above the first transporting unit 38. The guiding unit 39 includes guiding roller 47, third pressing roller 48, and fourth pressing roller 49 arranged so that the third pressing roller 48 and the fourth pressing roller 49 have contact with the periphery of the guiding roller 47 and form a passageway for the discharged banknote between the guiding roller 47 and the companion pressing rollers (48, 49). Around the guiding roller 47 is a U-shaped banknote passageway 40 where the banknote travels around more than half of the guiding roller 47. The folded over configuration of the U-shaped passageway enables the dispensing device 1 to be implemented in a compact space.

Similarly, the guiding unit 39 has companion pressure rollers to form a passageway for the discharged banknote. The discharged banknote is driven by the first roller 44 at a substantially higher speed than the feed roller 34.

To prevent damage to the discharged banknote, the feed roller 34 is driven by a one-way clutch attached to the driving shaft 35 so that even though the discharged banknote is driven at a first speed by the feed roller 34, the discharged banknote may be continuously pulled at a second, higher speed by the first roller 44. The one-way clutch 36 allows the banknote to be continuously pulled at the higher speed, and does not limit the length of the banknote that may be pulled at a higher speed.

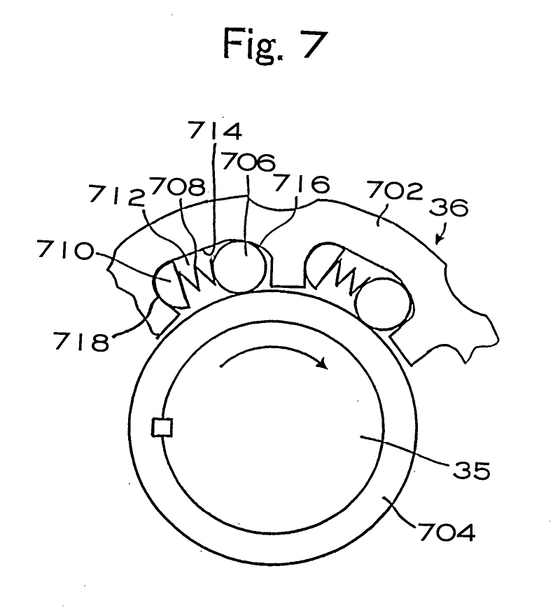

In reference to FIG. 7, feed roller 34 is a friction roller which is cylindrical in shape and is fixed at the outer surface of the outer race 702 of the one-way clutch 36. Alternatively, the feed rollers and companion rollers may be cylindrical segments arranged oppositely, to reduce cost while maintaining positive contact with the banknote. In one embodiment, the feed roller 34 comprises a material with a high coefficient of friction as well as durability and high wear resistance. Ethylene Propylene Diene Monomer (EPDM) is an example of a suitable material for the feed roller 34.

The one-way clutch 36 includes an outer race 702 and an inner race 704 where the inner race 704 is fixed to a driving shaft 35. On the interior region of the outer race 702 are a number of holding grooves 712. Each holding groove 712 comprises a locking wall 716, a releasing wall 714, and a retainer wall 718.

Each holding groove 712 is U-shaped and contains a retainer 710, a spring 708, and a ball 706 that are arranged so that the retainer 710 is adjacent to the retainer wall 718, the ball 706 is adjacent to the locking wall 716, and the spring 708 is interposed between the retainer 710 and the ball 706 in order to bias the ball 706 against the locking wall 716.

As shown in FIG. 7, the locking wall 716 is a narrowing of the holding groove 612 in a dimension radial to the driving shaft 35 so that when the ball 706 is placed against the holding groove 712, the inner race 704 is driving the outer race 702 in a clockwise direction. This describes how the driving shaft 35 is driving the outer race 702 in the direction of rotation.

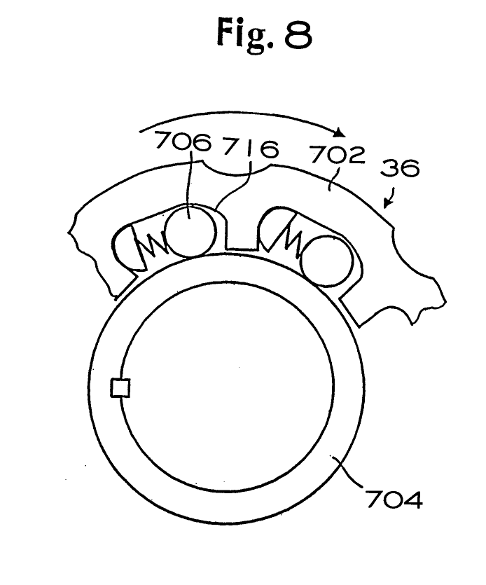

As shown in FIG. 8, when the outer race 702 is driven faster than the driving shaft 35, such as when the first roller 44 is pulling a banknote, the ball 706 is forced in the direction of the retainer 710 compressing the spring 708 and allowing the outer race 702 to slide over the inner race 704 to permit the outer race 702 to rotate faster in the direction of rotation than the inner race 704. This describes how the outer race 702 may be pulled faster than the rotation speed of the driving shaft 35 to prevent damage to a banknote.

Referring again to FIG. 3, the second transporting unit 41 includes a second roller 51, a diverting unit 42, a third sensor 78, and a drawing unit 31. The second transporting unit 41 receives the discharged banknote from the first transporting unit 38 and passes the discharged banknote through an intermediate portion of the banknote transporting unit 5.

If a banknote is detected as being defective or otherwise inappropriate for dispensing, it is rejected before being dispensed from the dispensing device 1. A rejected banknote is deflected by the diverting unit 42 and stored in the rejected banknote storing section 17 which is located below the separating plate 15.

The diverted banknote passes through the second transporting unit 41, around the second roller 51, is deflected by the diverting unit 42 and then pulled between rollers in the drawing unit 31 to enter the rejected banknote storing section 17. The rejected banknotes are thereby stored in a lower portion of the safe 14 to permit later examination and possible removal from circulation. The third sensor 78 detects the presence of the discharged banknote on the way to the rejected banknote storing section 17.

If the discharged banknote is not determined to be defective, the diverting unit 42 is activated to allow the discharged banknote to pass to the third transporting unit 43 which receives the discharged banknote from the second transporting unit 41 and passes the discharged banknote through the final portion of the banknote transporting unit 5.

The third transporting unit 43 includes a third roller 55, a fourth sensor 79, companion seventh pressing roller 56, and companion eighth pressing roller 57. The seventh pressing roller 56 and eighth pressing roller 57 are adjacent to the third roller and form a passageway for the discharged banknote between the companion rollers (56, 57) and the third roller 55. As discussed supra, if the discharged banknote is determined to be defective, the diverting unit 42 is not activated, and remains in a diverting position to conduct the discharged banknote to the rejected banknote storing section 17.

The second roller 51 and the third roller 55 are driven by a belt transmitting unit 54 that is driven by a friction roller 86 placed against the first roller 44. The belt transmitting unit 54 provides synchronization of the first roller 44, the second roller 51, and the third roller 55 to ensures the rollers are driven at the same speed. As shown in FIG. 3, the first roller normally rotates in a clockwise direction.

The friction roller 86 normally rotates in the opposite direction, in a counter clockwise direction. The friction roller 86 drives the second roller 51 and the third roller 55 in a counter clockwise direction. The synchronization and driving method is not limited to only a belt as other means such as gears may also be used.

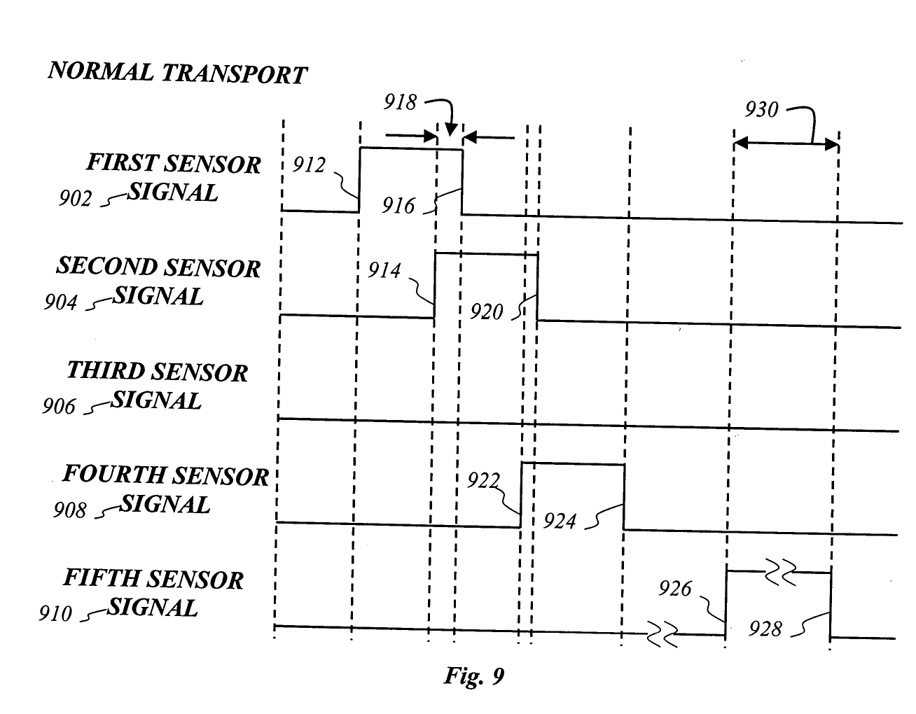

FIG. 9 shows receiving a banknote into the first transporting unit 38 and discharging the banknote from the third transporting unit 43 into the temporary storing section 60, also called a normal transport. The pattern of signals in FIG. 9 indicates the banknote transporting unit 5 has successfully transported the discharged banknote from the banknote supply storing section 24 to the temporary storing section 60.

The first sensor 75 asserts the first sensor signal 902. The rising edge 912 of the first sensor signal 902 indicates the leading edge of the discharged banknote is detected by the first sensor 75 and is considered a detecting condition. The first sensor signal 902 remains at a high value while the banknote is present next to the first sensor 75 during receipt into the banknote transporting unit 5.

The second sensor 76 asserts the second sensor signal 904. The rising edge 914 of the second sensor signal 904 indicates the leading edge of the discharged banknote is detected by the second sensor 76 and is considered a detecting condition. The second sensor signal 904 remains at a high value while the banknote is present next to the second sensor 76 during receipt into the banknote transporting unit 5.

At a predetermined time, the falling edge 916 of the first sensor signal is received by the banknote dispensing controller 7 indicating the trailing edge of the discharged banknote is detected. This is considered a non-detecting condition. The length overlap 918 indicates the length of the discharged banknote since the transport speed of the transporting unit and the distance between the first sensor 75 and the second sensor 76 are known. The banknote dispensing controller 7 compares the length overlap 918 with a range of acceptable values to determine whether the discharged banknote is acceptable for dispensing.

If the length overlap 918 is acceptable, the diverting solenoid 85 is activated to allow the acceptable banknote to pass through the second transporting unit 41 to the third transporting unit 43 and into the temporary storing section 60. As the discharged banknote passes through the third transporting unit 43, the fourth sensor 79 detects the leading edge 922 and the trailing edge 924 of the transported banknote indicating the banknote was successfully passed to the temporary storing section 60. Once a predetermined number of discharged banknotes have been successfully transported to the temporary storing section 60, the package dispensing unit 6 is activated to push the accumulated banknotes in the temporary storing section out to the dispensing slot 63.

When the accumulated discharged banknotes are pushed to the dispensing slot 63, they are detected by the fifth sensor 80 also called the dispensed banknote sensor 80. The rising edge 926 of the fifth sensor signal 910 indicates the accumulated banknotes are newly detected in the dispensing slot 63.

The dispensed banknotes will remain in the dispensing slot 63 until grasped and removed by a user. The dispensing time 930 indicates how long the dispensed banknotes are waiting in the dispensing slot 63. Once the accumulated banknotes are grasped and removed from the dispensing device 1, the falling edge 928 will indicate the banknotes are no longer in the dispensing slot 63.

If the accumulated banknotes are not removed in a predetermined amount of time, the banknote dispensing control unit 7 causes an alarm to sound indicating to the user is requested to remove the dispensed banknotes that are protruding from the dispensing slot. Similarly, if the banknote dispensing control unit 7 receives another request to discharge banknotes before the previous package of accumulated banknotes has been removed from the dispensing slot, the alarm will sound indicating this error condition.

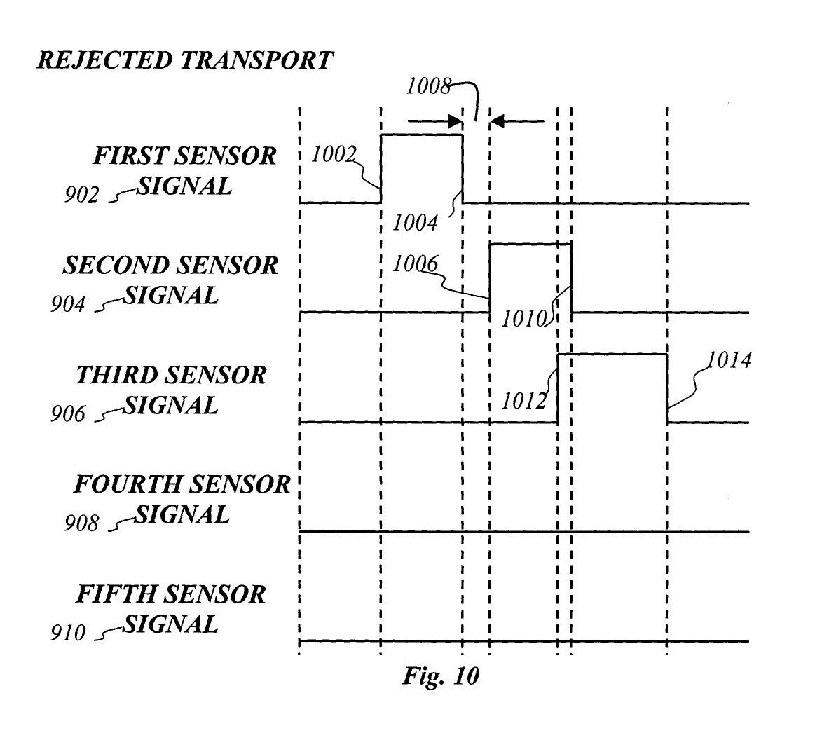

FIG. 10 shows receiving a banknote into the first transporting unit 38 and discharging the banknote from the second transporting unit 41 into the rejected banknote storing section 17, also called a rejected transport. The pattern of signals in FIG. 10 indicates the banknote transporting unit 5 has successfully transported the discharged banknote from the banknote supply storing section 24 to the rejected banknote storing section 17.

The first sensor 75 asserts the first sensor signal 902. The rising edge 1002 of the first sensor signal 902 indicates the leading edge of the discharged banknote is detected by the first sensor 75 and is considered a detecting condition. The first sensor signal 902 remains at a high value while the banknote is present next to the first sensor 75 during receipt into the banknote transporting unit 5. The falling edge 1004 of the first sensor signal indicates the trailing edge of the discharged banknote was detected.

The rising edge 1006 of the second sensor signal 904 indicates the leading edge of the discharged banknote has reached the second sensor 76. Since the first sensor 75 and the second sensor 76 are spaced a distance apart that is less than the expected length of the discharged banknote, an overlapping time where both the first sensor signal 902 and the second sensor signal 904 simultaneously remain high in a detecting condition is expected.

If the overlap 918 is less than expected, or is a gap 1008 where no overlap occurs, then the banknote dispensing control unit 7 determines the discharged banknote is not acceptable for dispensing, the diverting solenoid 85 is not activated, which allows the unacceptable banknote to be routed through the second transporting unit 41 to the rejected banknote storing section 17.

The third sensor 78 asserts the third sensor signal 906. The rising edge 1012 of the third sensor signal 906 indicates the leading edge of the discharged banknote is detected by the third sensor 78 and is considered a detecting condition. The third sensor signal 906 remains at a high value while the banknote is present next to the third sensor 78 during transport to the rejected banknote storing section 17.

The falling edge 1014 of the third sensor signal 906 indicates the discharged banknote has been successfully transported to the rejected banknote storing section 17. In all cases, the banknote dispensing control unit 7 expects the rising and falling edges to be spaced a predetermined distance apart in time. If a particular sensor indicates a value outside acceptable parameters, a problem such as a jamming condition is detected.

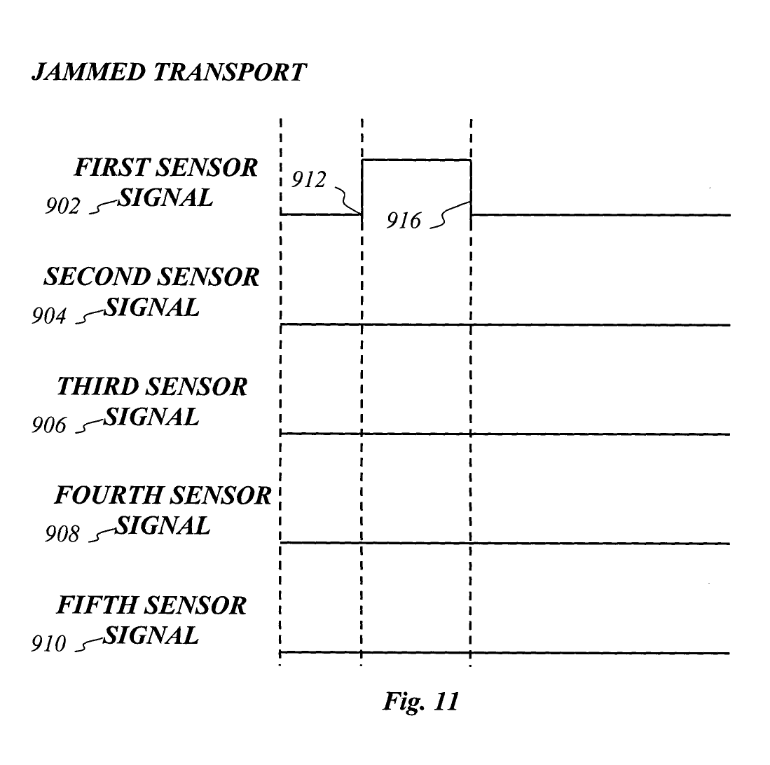

In reference to FIG. 11, a discharged banknote has been detected by the first sensor 75, but the banknote was not successfully detected by subsequent sensors. This indicates an error condition like a jamming of the banknote in the banknote transporting unit 5 or the failure of one or more sensors. The banknote dispensing control unit 7 detects this condition and stops motors 81 and 50.

The banknote dispensing control unit 7 receives and processes signals from the sensors and determines the proper control of the first motor 81 (not shown), the second motor 50, the activation of the diverting unit, and the movement of the package dispensing unit 6. The banknote dispensing control unit 7 can include a microprocessor with appropriate interface circuits under the control of a microprogram, or can include discrete electronic components used to perform the controlling functions.

Those skilled in the art will appreciate that various adaptations and modifications of the just-described preferred embodiment can be configured without departing from the scope and spirit of the invention. Therefore, it is to be understood that, within the scope of the amended claims, the invention may be practiced other than as specifically described herein.

What is claimed is:

1. A token dispensing and banknote changing device, comprising:
a banknote dispensing unit for dispensing banknotes;
a banknote receiving unit for receiving a banknote;
a token dispensing unit for dispensing tokens; and
a control unit operatively connected with the banknote dispensing unit, the banknote receiving unit, and the token dispensing unit to detect receipt of a banknote, dispense zero or more banknotes, and dispense zero or more tokens,
wherein the banknote dispensing unit, the banknote receiving unit, and the token dispensing unit are stacked in a vertical column with the banknote dispensing unit located at the top columnar position, the banknote receiving unit located at the middle columnar position, and the token dispensing unit located at the bottom columnar position.

2. The token dispensing and banknote changing device of claim 1,
wherein the banknote receiving unit includes a box-like chassis and has a banknote receiving guide located at the upper side of the box-like chassis, and
wherein the banknote dispensing unit includes a box-like chassis and has a banknote dispensing guide located at the lower side of the box-like chassis.

3. The token dispensing and banknote changing device of claim 1,
wherein the token dispensing unit includes a box-like chassis and has a token dispensing guide located at the lower side of the box-like chassis.

4. A token dispensing and banknote changing device, comprising:
a vertical chassis divided, from top to bottom, into a first compartment, a second compartment, and a third compartment;
a banknote dispensing unit for dispensing banknotes, the banknote dispensing unit disposed within the first compartment;
a banknote receiving unit for receiving a banknote, the banknote receiving unit disposed within the second compartment;
a token dispensing unit for dispensing tokens, the token dispensing unit disposed within the third compartment, the token dispensing unit having a supply hopper for retaining a supply of tokens for dispensing; and
a control unit placed within the vertical chassis and operatively connected with the banknote dispensing unit, the banknote receiving unit, and the token dispensing unit, the control unit detects receipt of a banknote, dispenses zero or more banknotes, and dispenses zero or more tokens.

5. The token dispensing and banknote changing device of claim 4, further comprising:
an opening in the rear of the third compartment, on the side opposite to the token dispensing guide, to allow the tokens to be automatically resupplied by an automatic token resupply device into the token dispensing unit supply hopper.

6. The token dispensing and banknote changing device of claim 5,
wherein the banknote dispensing unit, banknote receiving unit, and the token dispensing unit are removable from the chassis.

7. The token dispensing and banknote changing device of claim 6, further comprising:
a first door for enclosing the first compartment and the second compartment of the chassis, the first door being a planar member with a first edge, a second edge, a third edge, and a fourth edge,
wherein the first edge is located opposite to the third edge and the second edge is located opposite to the fourth edge.

8. The token dispensing and banknote changing device of claim 7, further comprising:
a first locking mechanism for securing the first door to the chassis, the first locking mechanism being located adjacent to the first edge of the first door.

9. The token dispensing and banknote changing device of claim 8, further comprising:
a first hinge for connecting the predetermined edge of the first door to the chassis,
wherein the first hinge allows the first door to be selectively opened and closed by pivoting on the first hinge.

10. The token dispensing and banknote changing device of claim 9,
wherein the first hinge is located on the third edge of the first door.

11. The token dispensing and banknote changing device of claim 9,
wherein the first hinge is located on one of the second edge or the fourth edge of the first door.

12. The token dispensing and banknote changing device of claim 6, further comprising:
a second door for enclosing the third compartment of the chassis, the second door being a planar member with a first edge, a second edge, a third edge, and a fourth edge,
wherein the first edge is located opposite to the third edge and the second edge is located opposite to the fourth edge.

13. The token dispensing and banknote changing device of claim 12, further comprising:
a second locking mechanism for securing the second door to the chassis, the second locking mechanism being located adjacent to the first edge of the first door.

14. The token dispensing and banknote changing device of claim 13, further comprising:
a second hinge for connecting the predetermined edge of the second door to the chassis,
wherein the second hinge allows the second door to be selectively opened and closed by pivoting on the second hinge.

15. The token dispensing and banknote changing device of claim 14,
wherein the second hinge is located on the third edge of the second door.

16. The token dispensing and banknote changing device of claim 14,
wherein the second hinge is located on one of the second edge or the fourth edge of the second door.

17. The token dispensing and banknote changing device of claim 12, further comprising:
a token resupply door mounted on a hinge within the upper section of the second door, the token resupply door being opened to manually resupply tokens into the token dispensing unit supply hopper.

18. A token dispensing and banknote changing device, comprising:
a vertical chassis divided, from top to bottom, into a first compartment, a second compartment, and a third compartment, the vertical chassis having a front face, a rear face, two side faces, a top face, and a bottom face, the vertical chassis being closed except for the front face and a predetermined portion of the rear of the third compartment;
a banknote dispensing unit for dispensing banknotes, the banknote dispensing unit having a banknote dispensing guide for outputting one or more dispensed banknotes, the banknote dispensing guide located at approximately the lower side of the banknote dispensing unit, the banknote dispensing unit being disposed within the first compartment and oriented so that the banknote dispensing guide protrudes out of the front face of the vertical chassis;
a banknote receiving unit for receiving a banknote, the banknote receiving unit having a banknote receiving guide for receiving a banknote, the banknote receiving guide located at approximately the upper side of the banknote dispensing unit, the banknote receiving unit being disposed within the second compartment and oriented so that the banknote receiving guide protrudes out of the front face of the vertical chassis;
a token dispensing unit for dispensing tokens, the token dispensing unit having a token dispensing tray located at approximately the lower side of the token dispensing unit, the token dispensing unit being disposed within the third compartment and oriented so that the token dispensing tray protrudes out of the front face of the vertical chassis, the token dispensing unit having a supply hopper for retaining a supply of tokens for dispensing; and
a control unit placed within the vertical chassis and operatively connected with the banknote dispensing unit, the banknote receiving unit, and the token dispensing unit, the control unit detects receipt of a banknote, dispenses a predetermined number of banknotes, and dispenses a predetermined number of tokens.
